(19) United States
(12) Patent Application Publication
(10) Pub. No.: US 2017/0041584 A1
(43) Pub. Date: Feb. 9, 2017

(54) Interactive Memorial System

(71) Applicant: Justin Jones, Charlotte, NC (US)

(72) Inventor: Justin Jones, Charlotte, NC (US)

(21) Appl. No.: 14/820,679

(22) Filed: Aug. 7, 2015

(51) Int. Cl. H04N 9/877; E04H 13/00; H04N 9/79; G06K 7/14; G06F 3/14; H04N 9/12

(52) U.S. Cl. CPC H04N 9/877; G06F 3/14; H04N 9/12; H04N 9/7904; G06K 7/1413; E04H 13/003

(57) ABSTRACT

An interactive memorial system includes a gravestone having a front side. A processor is mounted within the gravestone and an electronic memory is in communication with the processor. The electronic memory stores a plurality of video files. A display is mounted on the gravestone and faces away from the front side. The display is electrically coupled to the processor and the display displays the video files when the processor accesses selected ones of the video files from the electronic memory. An input assembly is electrically coupled to the processor and is mounted on the gravestone. The input assembly receives one of a plurality of codes. The processor accesses one of the video files associated with one of the codes.

### BACKGROUND OF THE DISCLOSURE

Field of the Disclosure

The disclosure relates to grave marker and memorial combination devices and more particularly pertains to a new grave marker and memorial combination device for providing video messages from a deceased to those who access such at their grave.

Summary of the Disclosure

An embodiment of the disclosure meets the needs presented above by generally comprising a gravestone having a front side. A processor is mounted within the gravestone and an electronic memory is in communication with the processor. The electronic memory stores a plurality of video files. A display is mounted on the gravestone and faces away from the front side. The display is electrically coupled to the processor and the display displays the video files when the processor accesses selected ones of the video files from the electronic memory. An input assembly is electrically coupled to the processor and is mounted on the gravestone. The input assembly receives one of a plurality of codes. The processor accesses one of the video files associated with one of the codes.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of an interactive memorial system according to an embodiment of the disclosure.

FIG. 2 is a top view of an embodiment of the disclosure.

FIG. 3 is a rear view of an embodiment of the disclosure.

FIG. 4 is a front view of an embodiment of the disclosure.

FIG. 5 is a schematic view of an embodiment of the disclosure.

### DESCRIPTION OF THE PREFERRED EMBODIMENT

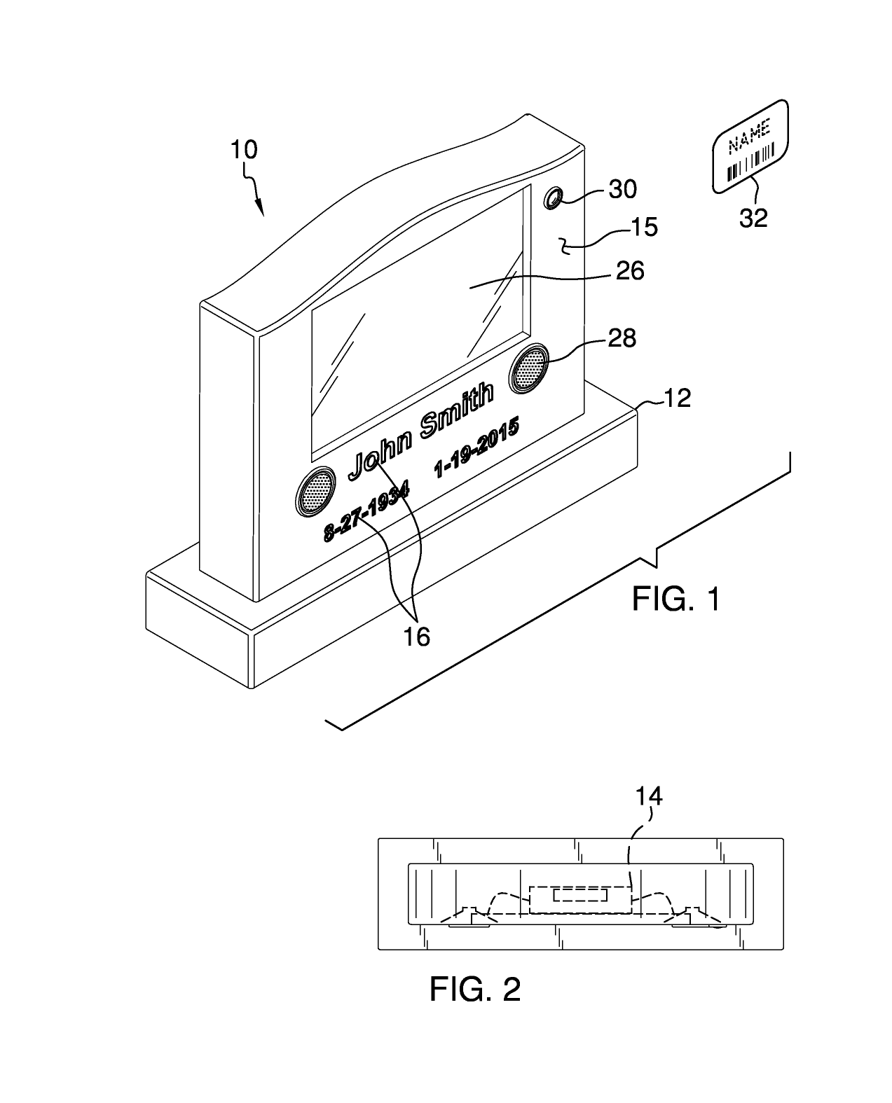

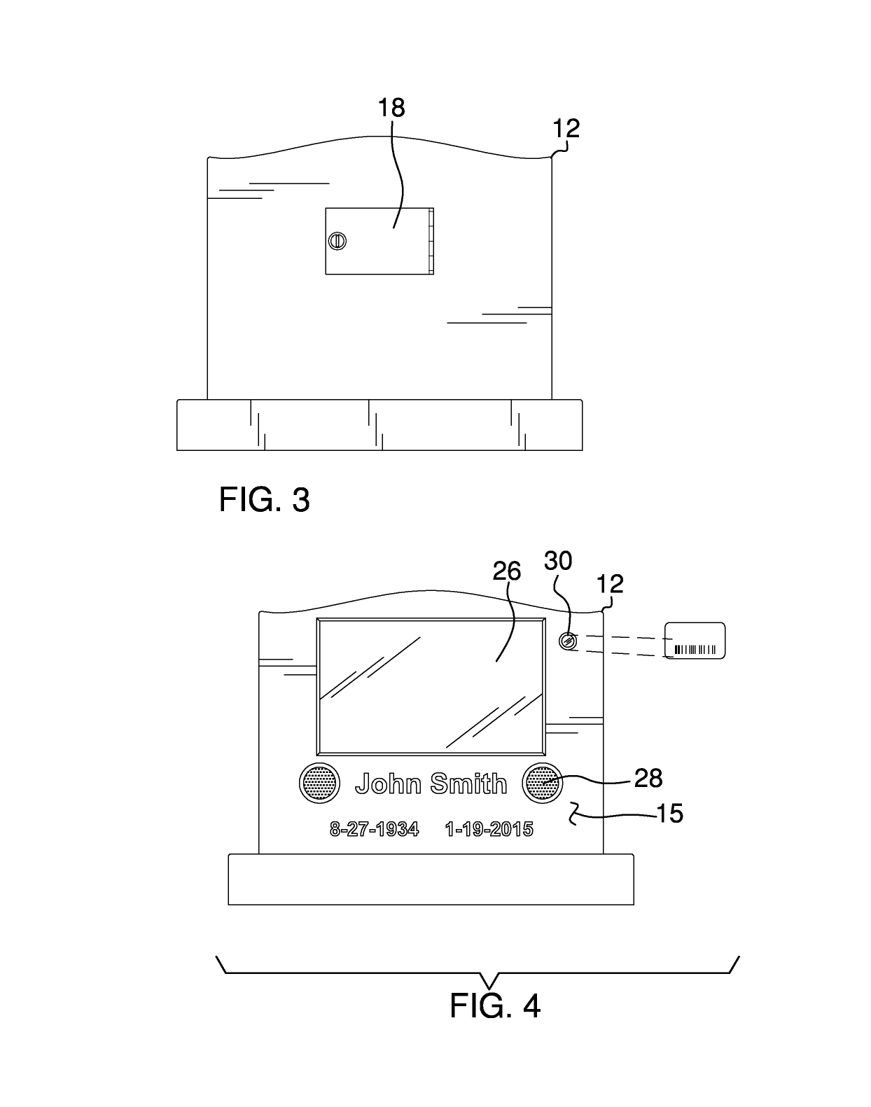

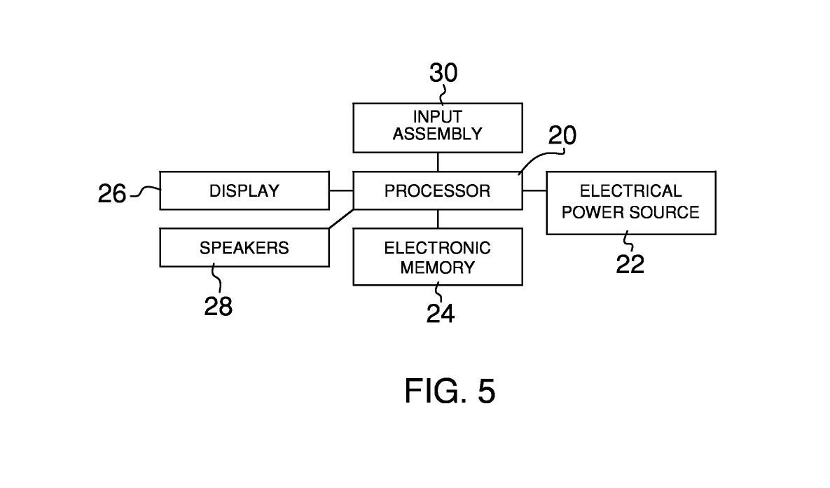

With reference now to the drawings, and in particular to FIGS. 1 through 5 thereof, a new grave marker and memorial combination device embodying the principles and concepts of an embodiment of the disclosure and generally designated by the reference numeral 10 will be described.

As best illustrated in FIGS. 1 through 5, the interactive memorial system 10 generally comprises a gravestone 12 that has a front side 15. The term “gravestone” is intended to mean any type of grave marker/indicator and may be comprised of natural stone, synthetic stone, or other materials conventionally used for grave markers. Alternatively, the gravestone 12 may be constructed of other materials such as metals or plastics which can withstand long term exposure to weather elements. The gravestone 12 will have a cavity 14 therein for reasons understood below. Indicia 16 stating the occupant of the grave marked by the gravestone 12 and other conventional information may be positioned on the gravestone 12. A door 18 may be positioned on a back side of the gravestone 12 for purposes of accessing the cavity 14.

A processor 20 is mounted within the gravestone 12 and may be powered by a conventional electronic power source 22 such as batteries, a hard wired source of electricity, photovoltaic cells mounted on the gravestone and combinations thereof. An electronic memory 24 is in communication with the processor 20 and stores a plurality of video files. The electronic memory 24 will typically be mounted within the gravestone 12 though the electronic memory 24 may be remote and accessed wirelessly with conventional means such as by cellular radio frequencies, Bluetooth and the like.

Cellular radio frequencies would typically allow the processor 20 to access internet databases while Bluetooth type technologies would allow access to handheld devices and electronic memory therein or utilize other wireless communications used by those handheld devices.

A display 26 is mounted on the gravestone 12 and faces away from the front side 15. The display 26 is electrically coupled to the processor 20. The display 26 may comprise any conventional display such as an LCD or LED display and may be sealed within the gravestone 12 to shield the display 26 from the elements. The display 26 displays the video files when the processor 20 accesses selected ones of the video files from the electronic memory 24. One or more speakers 28 is mounted on the gravestone 12 and electrically coupled to the processor 20 for audibly playing sound related to the video playing on the display 26.

An input assembly 30 is electrically coupled to the processor 20 and is mounted on the gravestone 12. The input assembly 30 allows entry one of a plurality of codes so that the codes are received by the processor 20. Each of the codes is discrete with respect to each other. The input assembly 30 may comprise any conventional input assembly means such as for example a keypad, a scanner for scanning a barcode, a scanner for detecting RFID chips, or a magnetic strip reader. The processor 20 is programmed to access one of the video files associated with one of the codes. However, the videos may provided in a set of videos wherein each set is associated with a particular person or group of people and the processor may include additional information as to which video, within a set of videos, is selected. For example, the processor 20 will select one of the sets when the code is entered but then select a video, or subset video, based upon additional input assembly information or upon known external information. Thus, the subset video played may be tailored to a particular date such as a birthday or anniversary or with respect to a holiday. In this manner, a user of the system 10 may provide a plurality of videos directed towards a particular person wherein each video may is accessed at an appropriate time. When a person enters the code, the processor 20 will access the subset of videos assigned to that person. The processor 20 will then access the current date and determine if one of the subset of videos is associated with that current date. If the current date is not relevant, a general video from that subset may be played or a non-specific video, accessible to a larger group or all persons, may be accessed.

Additionally, the input assembly 30 may be utilized to select a particular video which is accessible to the person who entered the code. Thus, certain, non specific videos may be accessible to all persons or particular groups of people and these may be accessed whenever desired by those capable of accessing those videos. It should be understood that the processor 20 may be programmed in any number of manners for allowing certain people to access particular videos at particular times. Moreover, it should be understood that the display may comprise a touch screen which may be used as the input assembly 30 or as an auxiliary inputting device for making selections of videos as offered.

A plurality of cards 32 may be provided wherein each of the cards 32 has one of the barcodes positioned thereon such that each card has a different barcode. Thus, each person may be provided a card 32 which is personal to that person so that the receiver of the card 32 has access only to those videos which are authorized for that person. The cards 32 may instead be provided with RFID chips, magnetic strips or the like for holding the code that is accessible by the input assembly 30.

In use, the headstone 12 is used in a conventional manner as a grave marker. However, the display 26 allows the deceased to provide multiple, different messages via videos which are seen on the display 26 and heard through the speakers 28. Moreover, the videos are such that they are personally directed to different people.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An interactive grave marking system comprising:
a gravestone having a front side;
a processor being mounted within said gravestone;
an electronic memory being in communication with said processor, said electronic memory storing a plurality of video files;
a display being mounted on said gravestone and facing away from said front side, said display being electrically coupled to said processor, said display displaying said video files when said processor accesses selected ones of said video files from said electronic memory;
an input assembly being electrically coupled to said processor and being mounted on said gravestone, said input assembly being configured to receive one of a plurality of codes; and
said processor being configured to access one of said video files associated with one of said codes.

2. An interactive grave marking system comprising:
a gravestone having a front side;
a processor being mounted within said gravestone;
an electronic memory being in communication with said processor, said electronic memory storing a plurality of video files;
a display being mounted on said gravestone and facing away from said front side, said display being electrically coupled to said processor, said display displaying said video files when said processor accesses selected ones of said video files from said electronic memory;
an input assembly being electrically coupled to said processor and being mounted on said gravestone, said input assembly being configured to receive one of a plurality of codes, each of said codes being discrete with respect to each other, said input assembly comprising a scanner for scanning a barcode;
said processor being configured to access one of said video files associated with one of said codes;
a plurality of cards, each of said cards having one of said barcodes positioned thereon such that each card has a different barcode.
